(19) United States
(12) Patent Application Publication
(10) Pub. No.: US 2021/0391705 A1
(43) Pub. Date: Dec. 16, 2021

(54) TEMPERATURE CONTROL METHOD FOR TERMINAL CONNECTION

(71) Applicants: Irek Khalyafovich GALIKEEV, Ufa (RU); Vitaliy Sergeevich KURINOV, Ufa (RU)

(72) Inventors: Irek Khalyafovich GALIKEEV, Ufa (RU); Vitaliy Sergeevich KURINOV, Ufa (RU); Sergey Ivanovich KOROTKOV, Ufa (RU)

(21) Appl. No.: 17/284,658

(22) PCT Filed: Feb. 21, 2020
(86) PCT No.: PCT/RU2020/000086

§ 371 Date: Apr. 12, 2021

(30) Foreign Application Priority Data
Oct. 16, 2019 (RU) 2019132891

(51) Int. Cl. H02H 5/04; H02H 1/00; G01K 3/00; G01K 7/16

(52) U.S. Cl. CPC H02H 5/047; G01K 7/16; G01K 3/005; H02H 1/0007

(57) ABSTRACT

A method for protecting an electrical grid against short circuits by controlling a temperature of terminal connections is disclosed, it can be used in industrial and consumer equipment to prevent fire hazardous situations. The technical result consists in the possibility of obtaining prompt and reliable information about a thermal state of terminal connections in an electrical circuit by avoiding an electrical connection between temperature sensors and a terminal connection. The metal device is used as a base for a temperature sensor. By using a triggering circuit, a voltage whose value depends on the temperature change is measured or compared or controlled with a predetermined voltage. If the temperature rises to a predetermined value or becomes higher than the predetermined value, the electrical circuit is opened or interrupted. After the temperature drops below the predetermined value, the electrical circuit is closed or restored.

### FIELD OF THE INVENTION

The invention relates to a method for protecting an electrical grid against short circuits by controlling a temperature of terminal connections and can be used in industrial and consumer equipment to prevent fire hazardous situations.

### BACKGROUND OF THE INVENTION

Fuses are well-known, and their operation is based on connecting a fuse and an electric current consumer in series and interrupting the resulting electric circuit when a fuse link blows at current exceeding a rated value.

Such fuses are commonly used to protect any electrical equipment, for example, to prevent wires of a consumer electrical grid from being overheated in the event of short circuits. However, if the fuse blows, further circuit operation is only possible if the blown fuse link is replaced. Moreover, an illiterate increase in a rated current can result in damage to electrical wiring due to high temperatures and even cause a fire.

In addition to the fuses, automatic circuit-breakers are often used, the operation of which is also based on interrupting the electrical circuit when the current exceeds the rated value. Furthermore, it is possible to reuse such an automatic circuit-breaker after its switches are flipped or temperature drops below the critical one. However, in this case, if the conditions of use are violated, excessive current can damage sockets and other elements of an electrical installation, as well as result in a fire hazardous situation.

RU2023286 discloses a method for operating a temperature control device, which is closest to the present invention and performed as follows. When a 200 V power supply is turned on, a control current flowing through a control electrode is rectified at a diode bridge and is fed through a voltage limiter to a voltage divider and a comparator. A voltage at a non-inverting input of the comparator is greater than at an inverting input, which causes the comparator to trigger. The comparator triggering in turn causes a second transistor switch to turn on. When a control current of a triac reaches a turn-on current, the triac turns on, and it turns off when a mains voltage drops to zero. Further, the process is repeated. As temperature increases, a resistance of a thermistor decreases, and when the voltage at the non-inverting input becomes less than at the inverting input, a first transistor switch turns off, thereby making it impossible for the triac to turn on. In this case, the thermistor begins to cool down, its resistance increases, and the voltage at the non-inverting input of the comparator therefore increases. When the voltage at the non-inverting input becomes greater than at the inverting input, the comparator and the second transistor switch are triggered, and the triac turns on.

The method disclosed in RU2023286 allows one to prevent electrical wiring from being heated to critical values, continue to power a consumer if the temperature drops to a normal temperature again, and when the temperature rises again, turn off the consumer again, thereby avoiding the melting of the electrical wiring insulation and its fire.

However, in this case, the terminal connection, in which overheating takes place, and the thermistors, which act as temperature sensors, are remote from each other and are electrically connected to each other. As a result, information about the overheating of the most vulnerable part—the terminal connection—is sent to the thermistors with a delay, during which the temperature at the terminal connection can rise to a critical level, thereby increasing the risk of a fire hazardous situation.

### SUMMARY OF THE INVENTION

The technical result of the present invention consists in the possibility of obtaining prompt and reliable information about a thermal state of terminal connections in an electrical circuit by avoiding an electrical connection between temperature sensors and the terminal connection.

The technical result is achieved by using a temperature control method for a terminal connection, which is performed as follows. A metal device is installed in the terminal connection or in direct proximity to the terminal connection. The metal device is used as a base for a temperature sensor. The property of changing an electrical resistance of bodies with a temperature change is used to take temperature measurements. By using a triggering circuit, a voltage whose value depends on the temperature change is measured or compared or controlled with a predetermined voltage. If the temperature rises to a predetermined value or becomes higher than the predetermined value, an electrical circuit is opened or interrupted. After the temperature drops below the predetermined value, the electrical circuit is closed or restored.

Due to the location of the metal device in the terminal connection or in direct proximity to the terminal connection, as well as the use of the metal device as the base for the temperature sensor, the closest arrangement of the temperature sensor to the controlled part of a protected object is achieved. This makes it possible to obtain prompt and reliable information about the thermal state of the most vulnerable part of the protected object, which is prone to fires—i.e. the terminal connection. The lack of the electrical connection between the temperature sensor and the metal device avoids false triggering, thereby increasing the reliability of the information. Only such a set of interconnections allows achieving the technical result—i.e. the efficiency of triggering.

The metal device may be made as a pin-type metal device configured to be clamped in the terminal connection, or as a terminal for a nut connection. As the metal device, pin contacts of a mains plug may be used. Furthermore, it is possible to use any design of the metal device acting as a temperature probe configured to avoid the electrical connection between the temperature sensors and the terminal connection.

In the context of the present invention, the direct proximity of the metal device serving as the base for the temperature sensor means that the metal device may be arranged at a distance of up to one meter from the terminal connection.

Depending on the design features of the triggering circuit, the voltage that depends on the temperature change may be either measured or compared or controlled. The voltage measurement and control are possible, for example, in the case of using the triggering circuit having a controlled Zener diode (see FIG. 5). The voltage comparison is possible, for example, when using the triggering circuit having an inverting comparator which allows one to obtain a low signal level at the output of the comparator (see FIG. 1), as well as the triggering circuit having a non-inverting comparator (see FIG. 4).

The terms “electrical circuit is opened or interrupted” mean that current supply to a consumer is interrupted in the electrical circuit. The terms “electrical circuit is closed or restored” mean that the current supply to the consumer is resumed in the electrical circuit. The choice between the terms “opened” and “interrupted”, as well as “closed” or “restored” with respect the electrical circuit depends on the constructive implementation of the triggering circuit.

### BRIEF DESCRIPTION OF THE DRAWINGS

FIG. 1 shows an inverting comparator connection circuit that implements a method according to the invention.

FIG. 2a shows a top view of a metal device involved, and FIG. 2b shows a side view of the metal device involved.

FIG. 3a shows a pin-type metal device configured to be clamped in a terminal connection, and

FIG. 3b shows a metal device made as a terminal for a nut connection.

FIG. 4 shows a non-inverting comparator connection circuit that implements the method according to the invention.

FIG. 5 shows a circuit having a controlled Zener diode, which implements the method according to the invention.

### DETAILED DESCRIPTION OF THE INVENTION

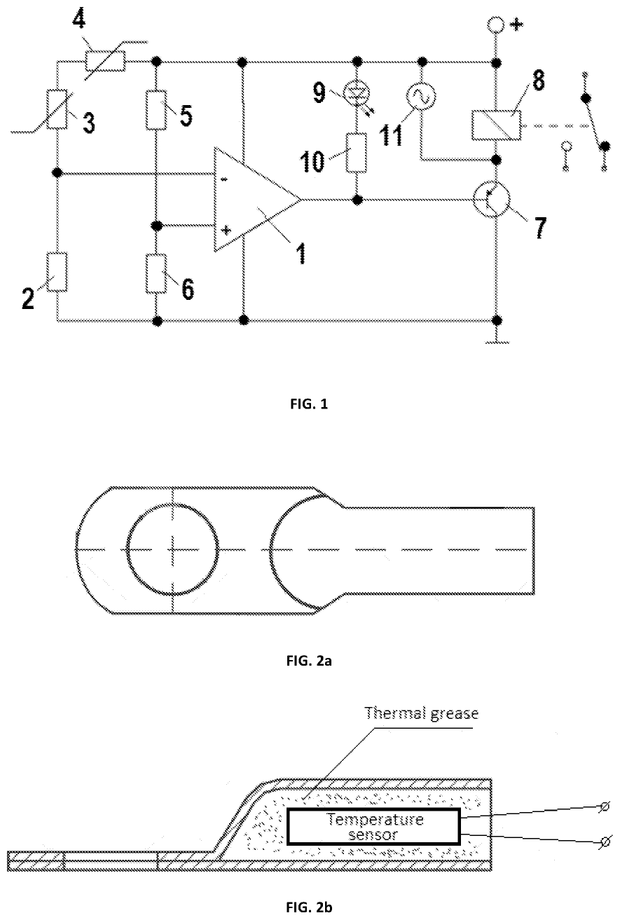

FIG. 1 shows an inverting comparator connection circuit that implements a temperature control method for a terminal connection according to the invention. The inverting comparator connection circuit comprises a comparator 1, both inputs of which are connected to voltage dividers. The first voltage divider connected to the inverting input (“−”) of the comparator 1 consists of a constant resistor 2 and thermistors 3, 4 which are temperature sensors and may be connected both in series and in parallel. The second voltage divider connected to the non-inverting input (“+”) of the comparator 1 consists of constant resistors 5, 6. The comparator 1 has an output connected to a transistor 7 and a relay 8. A resistor 10 is a current limiter for a light emitting diode (LED) 9 which serves as a terminal connection overheating indicator. An audible alarm 11 may be additionally used to alert users of terminal connection overheating.

As known, a resistance of a thermistor at a room temperature is very high and decreases when the thermistor is heated. According to the operational logic of the voltage divider, a voltage at the inverting input of the comparator 1 will be lower at the room temperature and will increase when the thermistors 3, 4 are heated.

To switch on the relay 8 depending on the temperature, it is necessary to set a switching threshold (switching threshold temperature). To do this, the non-inverting input of the comparator 1 is used, which is provided with a reference (constant) voltage. This reference voltage is set by the constant resistors 5, 6 which serve as the voltage divider.

The comparator compares the two voltage levels at the inverting and non-inverting inputs. If the voltage at the inverting input is greater than at the non-inverting input, then the output voltage from the comparator 1 will open the transistor 7 and cause the relay 8 to trigger. Once the voltage at the inverting input drops, due to a temperature decrease, below the voltage level at the non-inverting input, the transistor 7 will close and the relay 8 will turn off.

A metal device of any configuration is clamped in the terminal connection or arranged at a distance of up to one meter from the terminal connection, i.e. in direct proximity to the place of the potential overheating of electrical wiring, which allows one to quickly determine the occurrence of a critical situation. In the body of the metal device, there are temperature sensors—i.e. the thermistors 3, 4. The number of thermistors is determined by the number of terminal connections to be controlled. To provide the most accurate and fast heat transfer from the metal device to the temperature sensor, the latter is lubricated with a thermal grease (see FIG. 2a, FIG. 2b).

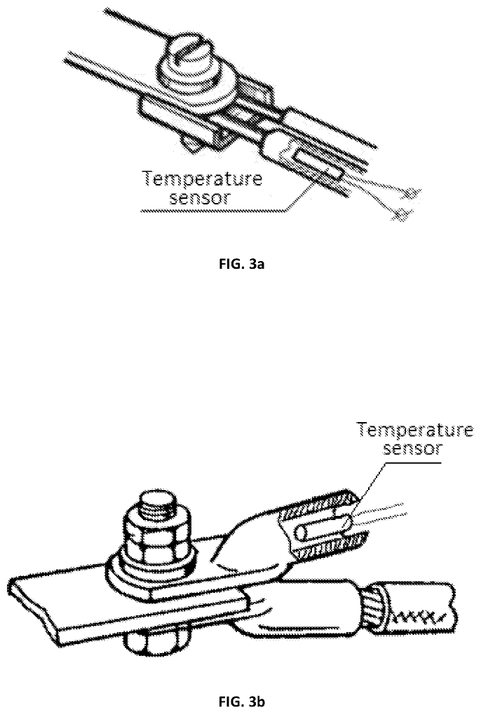

The most common types of metal devices are a pin-type device configured to be clamped in a terminal connection (see FIG. 3a) and a device made as a terminal for a nut connection (see FIG. 3b). Additionally, as the metal device, one can use pin contacts of a mains plug and control temperature in a socket which receives the mains plug with any triggering circuit implementing the method according to the invention (not shown).

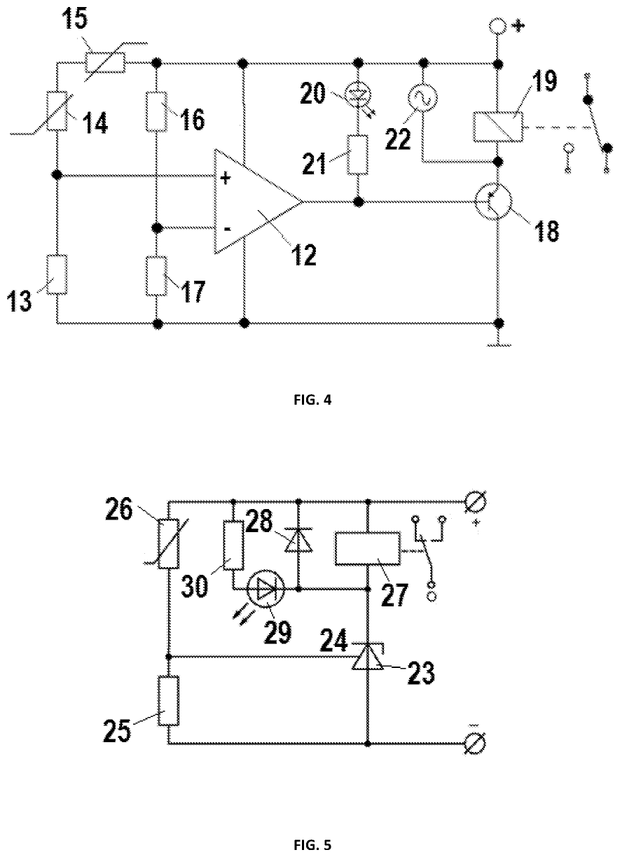

FIG. 4 shows a non-inverting comparator connection circuit that implements the method according to the invention. The non-inverting comparator connection circuit comprises a comparator 12, both inputs of which are connected to voltage dividers. The first voltage divider connected to the non-inverting input (“+”) of the comparator 12 consists of a constant resistor 13 and thermistors 14, 15 which are temperature sensors and may be connected both in series and in parallel. The second voltage divider connected to the inverting input (“−”) of the comparator 12 consists of constant resistors 16, 17. The comparator 12 has an output connected to a transistor 18 and a relay 19. A LED 20 having a current limiter implemented as a resistor 21 may serve as a terminal connection overheating indicator. An audible alarm 22 may also be additionally used to alert users of terminal connection overheating.

In this case, the voltage at the non-inverting input of the comparator 12 is lower at the room temperature and rises when the thermistors 14, 15 are heated. The switching threshold (switching threshold temperature) is defined by the inverting input of the comparator 12, which is provided with a reference (constant) voltage set by the voltage divider based on the constant resistors 16, 17.

If the voltage at the non-inverting input is greater than at the inverting input, the output voltage from the comparator 12 will open the transistor 18 and cause the relay 19 to trigger. Once the voltage at the non-inverting input drops, due to a temperature decrease, below the voltage level at the inverting input, the transistor 18 will close and the relay 19 will turn off.

FIG. 5 shows a circuit having a controlled Zener diode, which implements the method according to the invention. The circuit comprises a controlled Zener diode 23 having a control input 24 connected to a voltage divider consisting of a constant resistor 25 and a thermistor 26 having a negative temperature coefficient of resistance. The Zener diode has a cathode connected to a relay coil 27, a shunt diode 28, and a LED 29 having a current limiter implemented as a resistor 30. The LED may serve as a terminal connection overheating indicator.

The controlled Zener diode 23 is a key element of this temperature control device for the terminal connection. Once the voltage at the control electrode 24 reaches a threshold operation level, the controlled Zener diode 23 opens, and current flows from the positive terminal of the power supply through the relay coil 27, the cathode-anode of the controlled Zener diode 23 and further—to the negative terminal of the power supply. The voltage at the control electrode 24 is set by the voltage divider consisting of the constant resistor 25 and the thermistor 26 with the negative temperature coefficient of resistance. When the temperature of the terminal connection rises, the resistance of the resistor 25 remains constant, while the resistance of the thermistor 26 decreases.

Accordingly, as the resistance of the thermistor 26 drops, the voltage at the control electrode 24 of the controlled Zener diode 23 rises. Once this voltage becomes greater than the threshold operation level, the controlled Zener diode 23 opens, and the relay coil 27 is triggered, thereby disconnecting a load (consumer). After a while, the temperature of the terminal connection decreases. At the same time, the temperature of the thermistor 26 begins to drop, thereby leading to an increase in its resistance. Once the ratio of the resistance set by the constant resistor 25 to the resistance of the thermistor 26 which increases as a result of cooling ensures an appropriate voltage balance at which the voltage at the control electrode 24 of the controlled Zener diode 23 becomes less than the threshold operation level, the controlled Zener diode 23 will close again and turn off the relay coil 27. The cycle will repeat itself.

In this case, the switch-on and switch-off temperatures of the temperature control device for the terminal connection are defined by the constant resistor 25. Since the thermistor 26 has a certain thermal inertia due to its mass and protective coating, its switch-on temperature will slightly differ from its switch-off temperature. The diode 28 shunts the EMF arising in the coil-relay 27 and caused by the abrupt closing of the controlled Zener diode 23 and current interruption. The voltage appearing at the terminals of the relay coil 27 at this moment may exceed the supply voltage several times and make the controlled Zener diode 23 inoperative. The LED 29 with the limiting resistor 30 is configured to monitor the state of the relay coil 27 (on/off).

The invention makes it possible to prevent the overheating of electrical wiring and to avoid fires which spread from the clamps of switching equipment and are caused by the ignition of electrical wiring in power supply systems for providing residential, administrative and industrial facilities with voltage up to 0.4 kV.

1. A temperature control method for a terminal connection, comprising:
installing a metal device in the terminal connection or in direct proximity to the terminal connection,
using the metal device as a base for a temperature sensor,
measuring temperature based on a property of changing an electrical resistance of bodies with a temperature change,
by using a triggering circuit, measuring or comparing or controlling a voltage, the value of which depends on the temperature change, with a predetermined voltage,
if the temperature rises to a predetermined value or becomes higher than the predetermined value, opening or interrupting an electrical circuit, and
after the temperature drops below the predetermined value, closing or restoring the electrical circuit.

2. The control method of claim 1, comprising using, as the triggering circuit, an inverting comparator connection circuit which allows a low signal level to be obtained at a comparator output, or a non-inverting comparator connection circuit which allows a high signal level to be obtained at the comparator output, or a circuit having a Zener diode.

3. The control method of claim 1, wherein the metal device is made as a pin-type metal device configured to be clamped in the terminal connection, or as a terminal for a nut connection, or as pin contacts of a mains plug.

4. The control method of claim 1, wherein the metal device is installed at a distance of up to one meter from the terminal connection.
